(19) United States
(12) Patent Application Publication
(10) Pub. No.: US 2006/0066171 A1
(43) Pub. Date: Mar. 30, 2006

(54) Stator core for rotating electric machine

(75) Inventors: Satoshi Yanoi, Tsurugashima-shi (JP); Takeo Fukushima, Tsurugashima-shi (JP); Tadashi Yamazaki, Tsurugashima-shi (JP)

Correspondence Address: FULBRIGHT AND JAWORSKI LLP, 555 S. FLOWER STREET, 41ST FLOOR, LOS ANGELES, CA, 90071, US

(73) Assignee: Toyo Denso Kabusiki Kaisha

(21) Appl. No.: 10/953,719

(22) Filed: Sep. 28, 2004

(51) Int. Cl. H02K 1/12

(52) U.S. Cl. 310/254

(57) ABSTRACT

An outer rotor type split stator core which can be simply assembled at one time of core elements arranged in a circular form and possesses high rigidity, wherein core elements divided into magnetic pole units composed of yokes, a magnetic pole and a claw are coupled shiftably with one another in a specified range in the circumferential direction at yokes each provided with a downward projecting arm formed on one side thereof and an upward projecting arm formed on the other side thereof by engaging opposing projecting arms in neighboring core elements.

### BACKGROUND OF THE INVENTION

The present invention relates to a stator core of a rotating electric machine of the outer rotor type and, specifically, a split type stator core of a rotating electric machine.

Japanese Laid-Open Patent Publication No. 2000-50583 discloses a conventional stator core of the outer rotor type, which is divided into core elements 4 (FIG. 8) each representing a magnetic pole having a yoke part 1, a magnetic pole part 2 and a craw part 3. Each core element 4 has a downward salient hook 24 formed at one end of the yoke part 1 and an upward salient hook 25 formed at the other end of the yoke part 1 and is coupled with neighboring core elements by engaging its hooks with the neighbors' hooks. Thus, the core elements are assembled to form a ring-shaped stator core.

Japanese Laid-Open Patent Publication No. H11-234928 discloses an inner-rotor type stator core which is, as shown in FIGS. 9 and 10, composed of divided core elements 21 arranged in a circular form and joined with one another by engaging their recessed/protrusion parts, which is further held by a retainer 22 composed of rings for press-holding from up and down. Then, the stator core is finally fixed by pins 23 inserted in holes in the core elements and the retainer 22.

The problems of the prior art stator cores are as follows:

The conventional split type stator core requires complicated assembling of core elements by joining with one another by their hooks or protrusion/recessed parts.

The conventional split type stator core assembled, press-held by two rings of the retainer and fixed by the pins for fixing each core elements to press-holding rings has not enough rigidity in its radial direction and may cause deflection of the core in its thrust direction from the deformation of the retainer.

### SUMMARY OF THE INVENTION

It is therefore an object of the present invention to provide a split stator core of an outer rotor type rotating electric machine, which comprises a plurality of core elements representing magnetic pole units each having a yoke part, a magnetic pole part and a claw part, wherein the core elements are arranged in a circular form and simply assembled together at a time to form a single stator core in such a manner that the stator core elements each having a downward projecting arm formed on one side of the yoke part and an upward projecting arm formed on the other side of the yoke part are joined with one another movably in a specified range in the circumferential direction by engaging the downward projecting arm of one element with the upward projecting arm of a neighboring element and the upward projecting arm of the element with the downward projecting arm of another neighboring element.

Another object of the present invention is to provide a stator core of a rotating electric machine as defined above, which is finally fixed in the assembled state by pressing pins into holes formed by engagements of projecting arms of neighboring pairs of the core elements.

Another object of the present invention is to provide a stator core of a rotating electric machine as defined above, wherein each of the stator core elements has a yoke part having a circumferential surface finished by burring and press-sandwiched between retainers ribbed at their internal periphery.

### BRIEF DESCRIPTION OF THE DRAWINGS

FIG. 1 is a plan view of a core element of a stator core for a rotating electric machine according to the present invention.

FIG. 2 is a plan view showing two core elements engaging with each other at their upward and downward projecting arms.

FIG. 3 is a plan view showing a plurality of core elements arranged in a circular form to form a stator core by applying an inward pushing force to the circumference of core elements.

FIG. 4 is a plan view showing a stator core composed of a plurality of core elements according to the present invention.

FIG. 5 is a plan view of a stator core assembled of core elements each having a downward projecting arm and an upward projecting arm and finally fixed by inserting pins in holes formed by engagements of downward and upward projecting arms of the neighboring pairs of core elements.

FIG. 6 is a plan view of a stator and retainer rings.

FIG. 7 is a plan view of a retainer of FIG. 6.

FIG. 8 is a plan view showing an example of connection of two neighboring core elements in a conventional split-type stator core.

FIG. 9 is a plan view of an example of a conventional split-type stator core.

FIG. 10 is a front view of a stator core of FIG. 9, which is provided with retainers.

### PREFERRED EMBODIMENTS OF THE PRESENT INVENTION

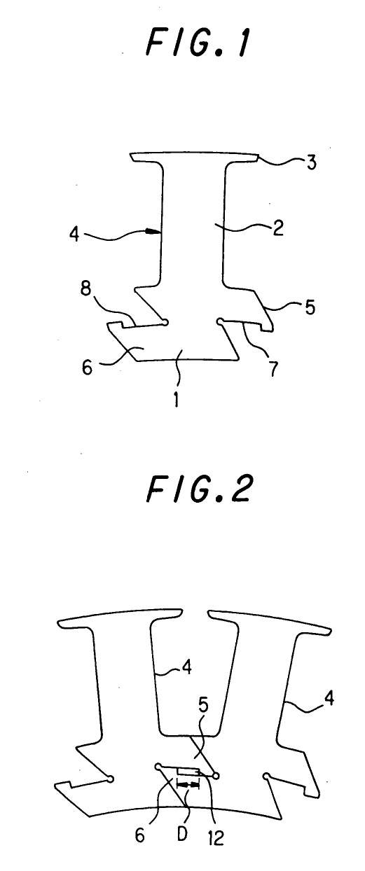

A stator core of a rotating electric machine according to the present invention is divided into core elements representing magnetic pole units each having a yoke part 4, a magnetic pole part 2 and a craw part 3 as shown in FIG. 1. The core element 4 is provided with a downward projecting arm 5 on one side of the yoke 1 and an upward projecting arm 6 on the other side of the yoke 1. The downward projecting arm 5 has a notch 7 and the upward projecting arm 6 has a notch 8. As shown in FIG. 2, each downward projecting arm 5 and upward projecting arm 6 in opposition in neighboring core elements 4 can be coupled with each other in a state being movable in a specified range D in the circumferential direction.

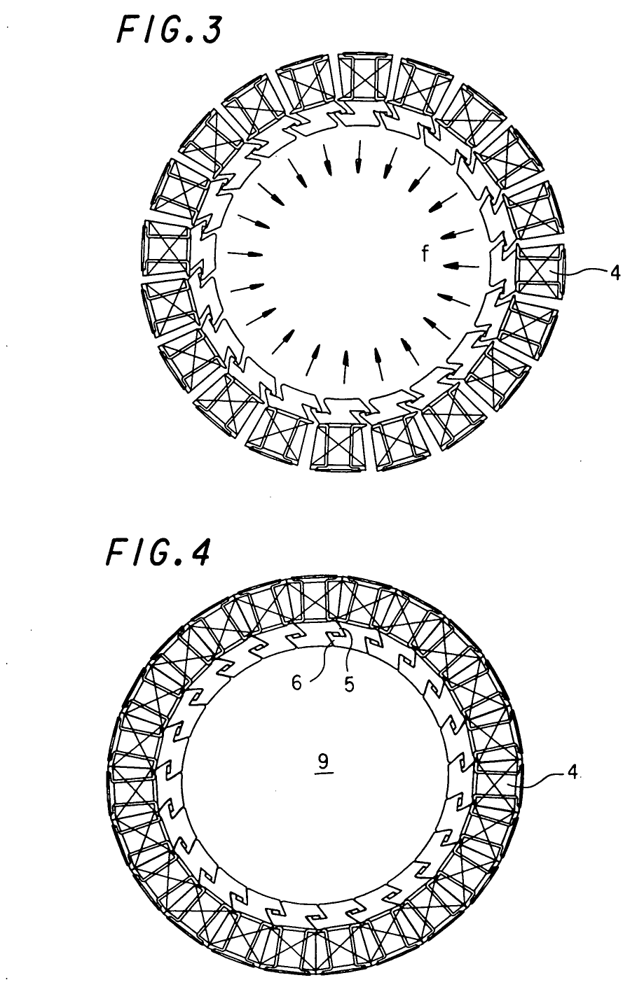

As shown in FIGS. 3 and 4, a specified number of core elements 4 are arranged in a circular form in which each downward projecting arm 5 and each upward projecting arm 6 in neighboring core elements are engaged movably with each other in the circumferential direction. When a small force f is applied to the circle of the core elements in the radial direction, it causes the circle of core elements to reduce its diameter by connecting the arms 5 and 6 of all neighboring pairs. Thus, the core elements can be assembled at a time by applying a small force to the circle of core elements.

In other words, all the stator core elements can be simply connected at a time in a single core unit with no need of making connection between the downward projecting arm 5 and the upward projecting arm 6 of each pair of neighboring core elements 4.

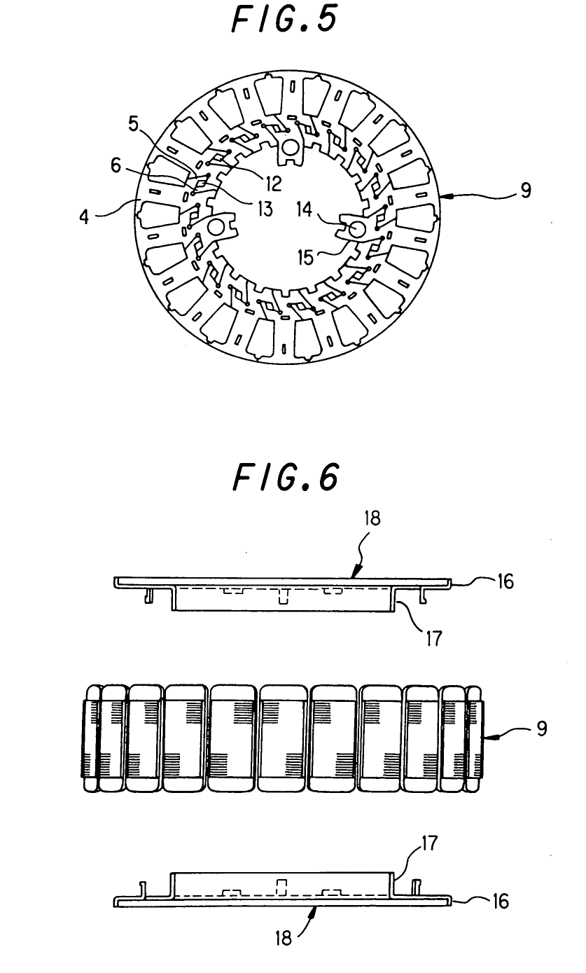

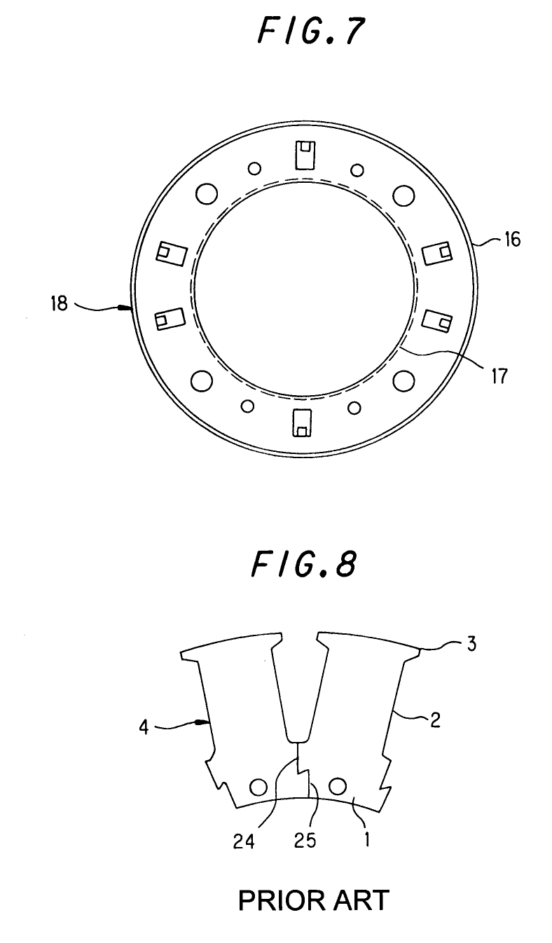

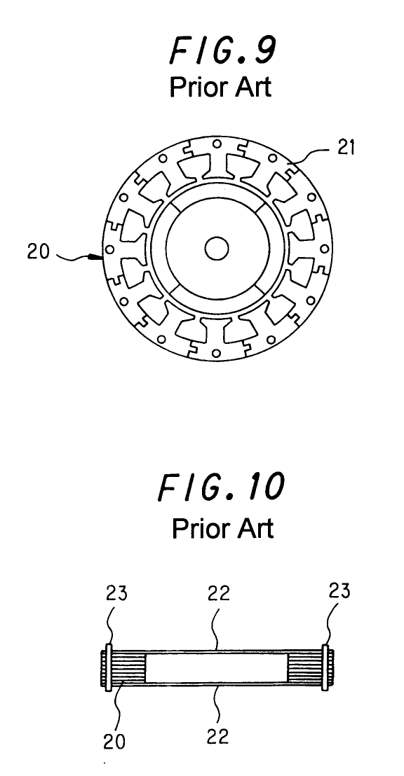

The stator core in the assembled state is finally fixed in the above-described assembled state by forcibly fitting a pin 13 into a hole 12 formed in the connected portion of the arms 5 and 6 of each pair of neighboring core elements 4 as shown in FIG. 5.

The press-fitting of pins 13 in all holes 12 formed in all connected pairs of the core elements 4 produces mutually counter forces in the circumferential direction between the connected pairs of the core elements. This results in firm connection of the core elements in the stator core 9 achieving sufficient rigidity of the stator core 9 in its radial direction.

The stator core 9 shown in FIG. 5 has a plurality of fixing holes 14 made in fixing bases 15 integrally with core elements 4 disposed at a specified interval on a circle of the core elements.

According to the present invention, the stator core 9 is provided on both sides with retainers 18 each having a burred portion 16 on the circumferential surface and a ribbed 17 portion at the inner periphery. The retainers are fastened together with plural core elements of the stator core 9 with the press-fitting pins 13. The retainers 18 possess the sufficient rigidity owing to their ribbed parts 17 and burred portion 16 and can stably hold the stator core 9 preventing the displacement of the stator core in the thrust direction from the flexible deformation of the retainer 18.

As be apparent from the foregoing, the split type stator core according to the present invention can be simply assembled in a single unit at a time by applying a small force f to the circumference of core elements arranged in a circular form since neighboring elements are coupled with one another by engaging their downward and upward projecting arms 5 and 6 in neighboring pairs of the elements each being movable in a specified range in the circumferential direction.

The stator core elements 4 thus assembled in a single stator core 9 which is fixed by tightly fitting pins 13 in respective holes 12 formed by coupling a downward projecting arm 5 and an upward projecting arm 6 in neighboring elements. This can increase the rigidity of the stator core 9.

According to the present invention, the stator core 9 is held by the retainers 18 each having a ribbed portion 17 at the inner periphery and a burred portion 16 of the circumference and therefore having the increased flexural strength, achieving the vibration proof durability of the stator core.

1. A split stator core of an outer rotor type rotating electric machine, comprising
a plurality of core elements representing magnetic pole units each having a yoke part including a circumferential surface on each side, a magnetic pole part and a claw part, said core elements being arranged in a circular form and unitarily coupled with one another at the yoke parts, wherein the stator core elements each having a downward projecting arm formed on one side of the yoke part and an upward projecting arm formed on the other side of the yoke part are joined with one another movably in a specified range in a circumferential direction by engaging the downward projecting arm of one element with the upward projecting arm of an neighboring element and the upward projecting arm of the element with the downward projecting arm of another neighboring element;
pins each press-fitted into holes formed by engagements of projecting arms of neighboring pairs of the core elements and fixing the core elements in the assembled state;
retainers, each ribbed at its inner Periphery and burred at its outer periphery, wherein the circumferential surfaces of the yoke parts of the core elements in the assembled state are press-sandwiched between the retainers.

2. (canceled)
